(19) United States
(12) Patent Application Publication
(10) Pub. No.: US 2021/0031326 A1
(43) Pub. Date: Feb. 4, 2021

(54) Positioning Device for a Machine Tool, Machine Tool and Positioning Method

(71) Applicant: Robert Bosch GmbH, Stuttgart (DE)

(72) Inventors: Aldo Di Nicolantonio, Zuchwil, Solothurn (CH); Stefano Delfini, Bettlach (CH); Bruno Sinzig, Oberbipp (CH); Massimo Tolazzi, Tavagnacco (IT); Florian Esenwein, Leinfelden-Echterdingen (DE)

(21) Appl. No.: 16/965,750

(22) PCT Filed: Feb. 18, 2019
(86) PCT No.: PCT/EP2019/053933

§ 371 Date: Jul. 29, 2020

(30) Foreign Application Priority Data
Feb. 20, 2018 (DE) 10 2018 202 517.7

(51) Int. Cl. B24B 23/02; B25F 5/00

(52) U.S. Cl. CPC B24B 23/022; B24B 45/006; B25F 5/001

(57) ABSTRACT

A positioning device for a machine tool, in particular for a hand-held machine tool having a rotationally driveable output spindle, includes at least one positioning unit which is provided to stop and/or retain at least one output spindle of the machine tool and/or an insert tool arranged on the output spindle of the machine tool in at least one defined position. The positioning unit is provided for stopping and/or retaining the output spindle and/or the insert tool arranged on the output spindle in at least one defined position in an automatic manner, in particular without a user intervention, in particular starting from a working movement of the output spindle and/or of the insert tool arranged on the output spindle.

### PRIOR ART

There are already known positioning devices for power tools, power tools having a positioning device, and methods for positioning an output spindle of a power tool, and/or an insert tool arranged on the output spindle of the power tool, the positioning devices comprising a positioning unit that is designed to stop and/or hold an output spindle of the power tool, and/or an insert tool arranged on the output spindle of the power tool, in at least one defined position. The already known positioning devices are realized as manually operable spindle stopping devices.

### DISCLOSURE OF THE INVENTION

The invention is based on a positioning device for a power tool, in particular for a hand-held power tool having an output spindle that can be driven in rotation, having at least one positioning unit, which is designed to stop and/or hold at least one output spindle of the power tool, and/or an insert tool arranged on the output spindle of the power tool, in at least one defined position.

It is proposed that the positioning unit be designed to stop and/or hold the output spindle, and/or the insert tool arranged on the output spindle, automatically, in particular without a user intervention, in at least one defined position, in particular a defined rotational position relative to a housing unit of the power tool, in particular starting from a working motion, preferably a rotational motion, of the output spindle and/or of the insert tool arranged on the output spindle. “Designed” is to be understood to mean, in particular, specially programmed, configured set up and/or equipped. That an object is designed for a particular function is to be understood to mean, in particular, that the object fulfils and/or executes this particular function in at least one application state and/or operating state. The positioning unit may be realized as a magnetic, electronic and/or mechanical positioning unit. If the positioning unit is designed as a magnetic positioning unit, it is conceivable for the positioning unit to have, for example, a positioning element that is realized as a magnet and designed to act upon the output spindle, upon the insert tool arranged on the output spindle or upon a drive unit of the power tool that can drive the output spindle. If the positioning unit is designed as an electronic positioning unit, it is conceivable for the positioning unit to be realized, for example, so as to be at least partially integral with an open-loop or closed-loop control unit for controlling a drive unit by open-loop and/or closed-loop control, and to be designed to stop and/or hold the output spindle, and/or the insert tool arranged on the output spindle, automatically, in particular without a user intervention, in at least one defined position, in particular a defined rotational position relative to a housing unit of the power tool, in particular starting from a working motion, preferably a rotational motion, of the output spindle and/or of the insert tool arranged on the output spindle, in dependence on open-loop or closed-loop control of the drive unit. That “a unit is realized so as to be at least partially integral with a further unit” is to be understood to mean, in particular, that the unit and the further unit have at least one common component part and/or are arranged on a common printed circuit board. If the positioning unit is designed as a mechanical positioning unit, it is conceivable for the positioning unit to have, for example, at least one form-closure and/or force-closure element designed to act upon the output spindle, upon the insert tool arranged on the output spindle, or upon the drive unit that is able to drive the output spindle.

Preferably, the positioning unit, by stopping and/or holding the output spindle in a defined position, is designed to preset a defined mounting position of the output spindle in which the insert tool that can be arranged on the output spindle can be mounted/demounted in a user-friendly manner. In the defined mounting position, the output spindle can preferably be stopped and/or held, by means of the positioning unit, in a preset, fixed position relative to the housing unit. For example, it is conceivable that an alignment of the insert tool and/or of the output spindle can be sensed by means of the positioning unit, and that the drive unit, in particular an electric-motor unit, can be controlled in such a manner that the insert tool and/or the output spindle can be stopped and/or held in the defined position. It is conceivable for the positioning unit to have an actuator means designed to move a brake and/or a blocking element such as, for example, a spindle locking pin that is designed to stop and/or hold the insert tool and/or the output spindle in the defined position. It can advantageously be made possible, for example, for information provided on the insert tool (advertising, indication of direction of rotation, characteristic values or the like) to be easily and reliably read by an operator when the insert tool and/or the output spindle is at a standstill, such that advantageous delivery of information to an operator can be achieved.

Advantageously, user-friendly mounting/demounting of the insert tool on the output spindle can be made possible.

It is furthermore proposed that the positioning unit have at least one actuator element, which is designed to act mechanically and/or magnetically at least upon the output spindle, upon the insert tool arranged on the output spindle, or upon the drive unit of the power tool that is able to drive the output spindle. The actuator element may be realized as an inductively operating electric motor, as a bimetal actuator, as a hydraulic or pneumatic actuator, as a cylinder, as an electrochemical actuator, as an electromechanical actuator, as a piezoelectric actuator, as a magnetostrictive actuator, as a rheological actuator, as a shape-memory alloy, as an electroactive polymer actuator, or as another actuator element considered appropriate by persons skilled in the art. Preferably, the actuator element is designed to act directly or indirectly upon the output spindle, upon the insert tool arranged on the output spindle, or upon the drive unit that is able to drive the output spindle. For example, it is conceivable for the actuator element, in particular at least one end of a movable portion of the actuator element, to be designed to be moved into a, in particular single, recess, of the output spindle, of the insert tool or of a rotor shaft of the drive unit, in particular in order to stop and/or hold the output spindle, and/or the insert tool arranged on the output spindle, automatically, in particular without a user intervention, in at least one defined position, in particular a defined rotational position relative to the housing unit, in particular starting from a working motion, preferably a rotational motion, of the output spindle and/or of the insert tool arranged on the output spindle. It is also conceivable for the actuator element to be designed to move a magnetic element into a position relative to a further magnetic element arranged at a position, in particular a single position, of the output spindle, insert tool or rotor shaft of the drive unit, in particular in order to stop and/or hold the output spindle, and/or the insert tool arranged on the output spindle, automatically, in particular without a user intervention, in at least one defined position, in particular a defined rotational position relative to the housing unit, in particular starting from a working motion, preferably a rotational motion, of the output spindle and/or of the insert tool arranged on the output spindle. The design according to the invention makes it possible, advantageously, to realize a compact positioning unit. It is advantageously possible to realize an at least partially automatic and reliable stopping of the output spindle in a rotational position, in particular a single rotational position. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved. Advantageously, user-friendly mounting/demounting of the insert tool on the output spindle can be made possible.

It is additionally proposed that the actuator element be designed to move a mechanical and/or electromagnetic braking element of the positioning unit, or a mechanical engagement element of the positioning unit, that is designed to act at least upon the output spindle, upon the insert tool arranged on the output spindle, or upon the drive unit that is able to drive the output spindle. For example, it is conceivable for the actuator element to be designed to move at least one movably mounted engagement element, in particular a locking pin, into a, in particular single, recess of the output spindle, of the insert tool or of a rotor shaft of the drive unit, in particular in order to stop and/or hold the output spindle, and/or the insert tool arranged on the output spindle, automatically, in particular without a user intervention, in at least one defined position, in particular a defined rotational position relative to the housing unit, in particular starting from a working motion, preferably a rotational motion, of the output spindle and/or of the insert tool arranged on the output spindle. It is also conceivable for the actuator element to be designed to move a frictional braking element of the positioning unit in such a manner that the frictional braking element can be brought into contact with the output spindle, the insert tool or the rotor shaft of the drive unit, a rotational position of the output spindle, of the insert tool or of the rotor shaft of the drive unit being able to be monitored, by means of a sensor element of the positioning unit, in order selectively to initiate a braking operation in dependence on a rotational speed of the output spindle, of the insert tool or of the rotor shaft of the drive unit, in particular in order to stop and/or hold the output spindle, and/or the insert tool arranged on the output spindle, automatically, in particular without a user intervention, in at least one defined position, in particular a defined rotational position relative to the housing unit, in particular starting from a working motion, preferably a rotational motion, of the output spindle and/or of the insert tool arranged on the output spindle. It is likewise conceivable for the actuator element to be designed to move a magnetic braking element of the positioning unit in such a manner that the magnetic braking element can be brought into the vicinity of the output spindle, of the insert tool or of the rotor shaft of the drive unit, a rotational position of the output spindle, of the insert tool or of the rotor shaft of the drive unit being able to be monitored, by means of a sensor element of the positioning unit, in order selectively to initiate a braking operation in dependence on a rotational speed of the output spindle, of the insert tool or of the rotor shaft of the drive unit, in particular in order to stop and/or hold the output spindle, and/or the insert tool arranged on the output spindle, automatically, in particular without a user intervention, in at least one defined position, in particular a defined rotational position relative to the housing unit, in particular starting from a working motion, preferably a rotational motion, of the output spindle and/or of the insert tool arranged on the output spindle. Advantageously, a structurally simple positioning unit can be realized by means of the design according to the invention. It is advantageously possible to realize an at least partially automatic and reliable stopping of the output spindle in a rotational position, in particular a single rotational position. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved. Advantageously, user-friendly mounting/demounting of the insert tool on the output spindle can be made possible.

It is additionally proposed that the positioning unit have at least one damping element, which is designed to damp a mechanical engagement of an engagement element of the positioning unit, in particular in the output spindle or in the insert tool arranged on the output spindle.

The damping element is preferably realized as an elastomer damping element. It is also conceivable, however, for the damping element to be of a different design considered appropriate by persons skilled in the art, such as, for example, designed as a rubber element, as an air-cushion damping element, as a fluid damping element or the like. The damping element is preferably arranged on the engagement element, or on a recess in which the engagement element engages for the purpose of stopping and/or holding the output spindle or the insert tool. Advantageously, a long service life of the positioning unit can be achieved. Advantageously, it can be made possible to protect component parts during stopping and/or holding of the output spindle for the purpose of advantageous delivery of information to an operator.

It is furthermore proposed that the positioning device have at least one open-loop or closed-loop control unit, and at least one sensor unit, which has at least one sensor element for sensing a position of the output spindle and/or of the insert tool arranged on the output spindle, wherein a signal of the sensor element can be processed by the open-loop or closed-loop control unit for the purpose of controlling an actuator element of the positioning unit by open-loop and/or closed-loop control. An “open-loop or closed-loop control unit” is to be understood to mean, in particular, a unit having at least one set of control electronics. A “set of control electronics” is to be understood to mean, in particular, a unit have a processor unit and having a memory unit, and having an operating program stored in the memory unit. For example, it is conceivable for the sensor element to be designed to sense a rotational position of the output spindle, of the insert tool or of the rotor shaft of the drive unit, controlling of the actuator element, by means of the open-loop or closed loop control element, preferably being effected in dependence on a sensed rotational position. The design according to the invention enables stopping and/or holding of the output spindle, or of the insert tool arranged on the output spindle, to be realized in a particularly precise manner. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved. Advantageously, user-friendly mounting/demounting of the insert tool on the output spindle can be made possible.

It is also proposed that the sensor element be realized as a rotational-speed sensor, which is designed to sense at least one rotational speed of the output spindle or of the insert tool arranged on the output spindle, wherein the open-loop or closed-loop control unit determines a tripping instant of an actuator element of the positioning unit in dependence on the sensed rotational speed. The design according to the invention enables stopping and/or holding of the output spindle, or of the insert tool arranged on the output spindle, to be realized in a particularly precise manner. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved.

It is additionally proposed that the positioning device comprise at least one the open-loop or closed-loop control unit, and at least one sensor unit, which has at least one sensor element for sensing at least one characteristic and/or item of information of an insert tool arranged on the output spindle, wherein a defined position, in which the output spindle, and/or the insert tool arranged on the output spindle, can be stopped and/or held automatically, can be selected automatically, by means of the open-loop or closed-loop control unit, in dependence on the sensed characteristic and/or information of the insert tool arranged on the output spindle. The sensor element may be realized as a camera, as an RFID scanner, as an electronic read device, or the like. The design according to the invention enables stopping and/or holding of the output spindle, or of the insert tool arranged on the output spindle, to be realized in a particularly precise manner. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved.

Also proposed is a power tool, in particular a hand-held power tool, having at least one housing unit, having at least one output spindle, in particular that can be driven in rotation relative to the housing unit, and having at least one positioning device according to the invention. A “hand-held power tool” is to be understood here to mean, in particular, a power tool for performing work on workpieces, which can be transported by an operator without use of a transport machine. In particular, the hand-held power tool has a mass of less than 40 kg, preferably less than 10 kg, and particularly preferably less than 5 kg. Preferably, the power tool, in particular the hand-held power tool, is realized as an angle grinder, as a hand-held circular saw, as a plunge-cut circular saw, or the like. It is also conceivable, however for the power tool to be of another design, considered appropriate by persons skilled in the art. The power tool preferably comprises a quick-change clamping device arranged on the output spindle. Preferably, the quick-change clamping device comprises at least one clamping means, which has at least two clamping jaws that are mounted, in particularly pivotably, so as to be movable relative to the output spindle, for securing the insert tool at least axially on the output spindle. Advantageously, for example, information provided on the insert tool (advertising, indication of direction of rotation, characteristic values or the like) can be easily and reliably read by an operator when the insert tool and/or the output spindle is at a standstill, such that advantageous delivery of information to an operator can be achieved, in particular if the power tool is designed with a quick-change clamping device, in which an alignment of the insert tool relative to the quick-change clamping device may be relevant to enable the insert tool to be mounted on the output spindle.

The invention is also based on a method for positioning an output spindle of a power tool, and/or an insert tool arranged on the output spindle of the power tool, by means of a positioning device, in particular by means of positioning device according to the invention. It is proposed that, in at least one method step, the output spindle, and/or the insert tool arranged on the output spindle, be stopped and/or held automatically, in particular without a user intervention, in at least one defined position by means of a positioning unit of the positioning device, in particular starting from a working motion of the output spindle and/or of the insert tool arranged on the output spindle. It can advantageously be made possible, for example, for information provided on the insert tool (advertising, indication of direction of rotation, characteristic values or the like) to be easily and reliably read by an operator when the insert tool and/or the output spindle is at a standstill, such that advantageous delivery of information to an operator can be achieved. Advantageously, user-friendly mounting/demounting of the insert tool on the output spindle can be made possible.

It is additionally proposed that, in at least one method step, at least one position of the output spindle, and/or of the insert tool arranged on the output spindle, be sensed by means of the sensor unit of the positioning device, and the sensed position be processed by an open-loop or closed-loop control unit of the positioning device for the purpose of open-loop and/or closed-loop control of an actuator element of the positioning unit by the open-loop or closed-loop control unit. Advantageously, reliable and reproducible stopping of the output spindle can be achieved.

The positioning device according to the invention, the power tool according to the invention and/or the method according to the invention are/is not intended in this case to be limited to the application and embodiment described above. In particular, the positioning device according to the invention, the power tool according to the invention and/or the method according to the invention may have individual elements, component parts and units, and method steps, that differ in number from a number stated herein, in order to fulfill an operating principle described herein. Moreover, in the case of the value ranges specified in this disclosure, values lying within the stated limits are also to be deemed as disclosed and applicable in any manner.

### DRAWINGS

Further advantages are given by the following description of the drawing. The drawing shows an exemplary embodiment of the invention. The drawings, the description and the claims contain numerous features in combination. Persons skilled in the art will expediently also consider them individually and combine them to form appropriate further combinations.

There are shown:

FIG. 1 a power tool system, having a power tool according to the invention that comprises a positioning device according to the invention, and having an insert tool arranged on an output spindle of the power tool, in a schematic representation,

FIG. 2 a sectional view of a quick-change clamping device of the power tool arranged on the, for securing the insert tool in a release state, in a schematic representation,

FIG. 3 a detail view of a clamping means and of a driver means of the quick-change clamping device of the power tool, in a schematic representation, and

FIG. 4 a schematic method sequence of a method according to the invention for positioning the output spindle of the power tool and/or the insert tool arranged on the output spindle of the power tool.

### DESCRIPTION OF THE EXEMPLARY EMBODIMENT

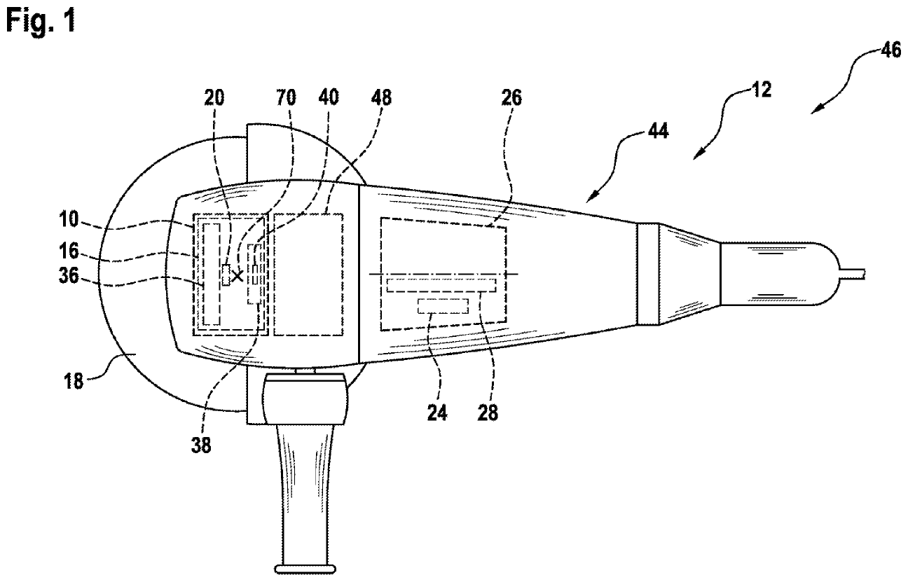

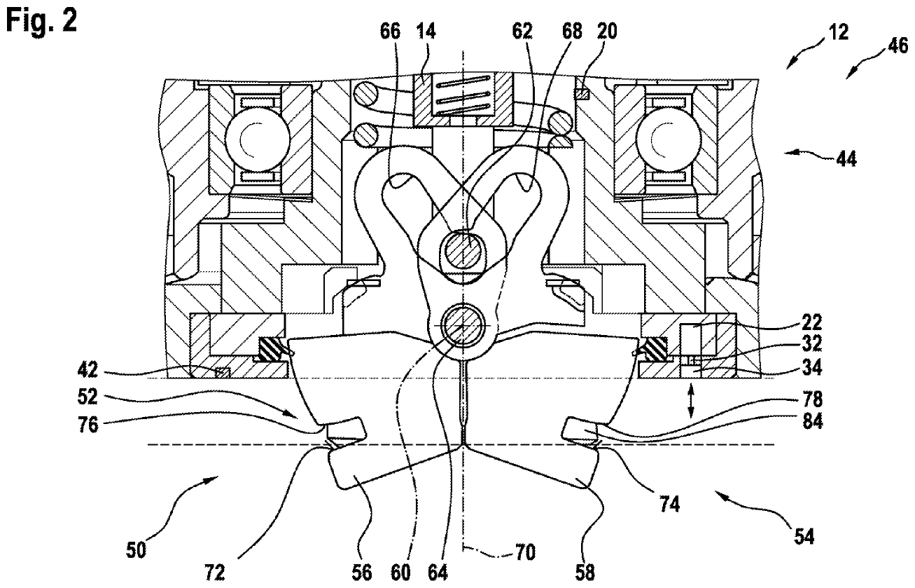

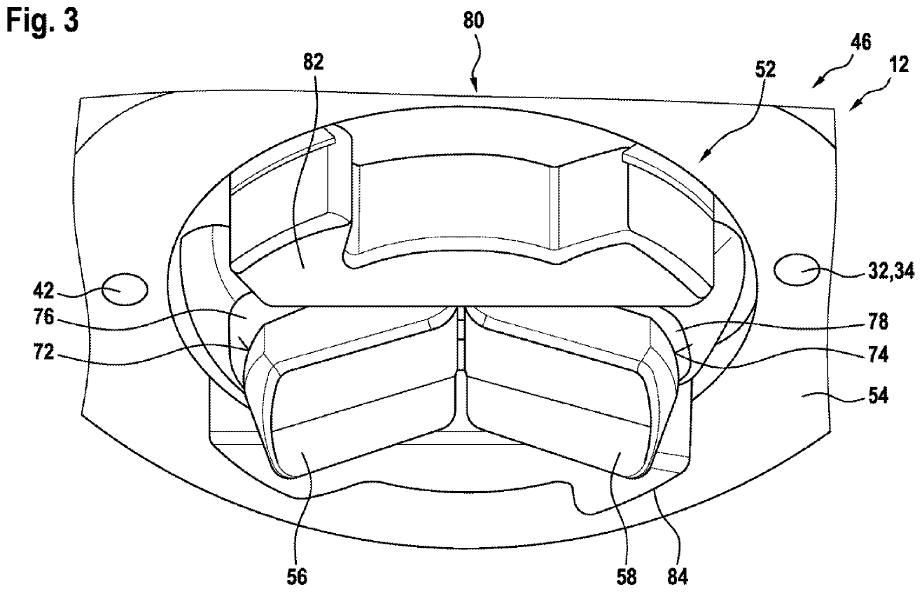

FIG. 1 shows a power-tool system 46, having at least one power tool 12, in particular a hand-held power tool, and having at least one insert tool 18 arranged an output spindle 14 of the power tool 12. In the exemplary embodiment represented in FIG. 1 the power tool 12 is realized as an angle grinder. It is also conceivable, however, for the power tool 12, in an alternative exemplary embodiment, not represented here, to be of a different design, considered appropriate by persons skilled in the art, such as, for example, designed as a hand-held circular saw, as a plunge-cut circular saw, or the like. The power tool 12 comprises at least one housing unit 44, at least the output spindle 14, in particular able to be driven in rotation relative to the housing unit 44, and at least one positioning device 10. The housing unit 44 is preferably designed to receive and/or carry a drive unit 26, in particular an electric-motor unit, and the output spindle 14 of the power tool 12, in a manner already known to persons skilled in the art. The drive unit 26 is designed to drive, in particular in rotation, the insert tool 18 when it has been arranged on the output spindle 14, via a transmission unit 48 of the power tool 12 or directly, in a manner already known to persons skilled in the art. The insert tool 18 can be fixed to the output spindle 14 of the power tool 12 by means of a quick-change clamping device 50 (see FIGS. 2 and 3) of the power tool 12. The quick-change clamping device 50 is preferably connected to the output spindle 14 in a rotationally fixed manner.

The positioning device 10 for the power tool 12, in particular the hand-held power tool having the output spindle 14 that can be driven in rotation, comprises at least one positioning unit 16, which is designed to stop and/or hold at least the output spindle 14 of the power tool 12, and/or the insert tool 18 arranged on the output spindle 14 of the power tool 12, in at least one defined position. The positioning unit 16 is designed to stop and/or hold the output spindle 14, and/or the insert tool arranged on the output spindle 14, automatically, in particular without a user intervention, in at least one defined position, in particular starting from a working motion of the output spindle 14 and/or of the insert tool 18 arranged on the output spindle 14. Preferably, the positioning unit 16, by stopping and/or holding the output spindle 14 in a defined position, is designed to preset a defined mounting position of the output spindle in which the insert tool 18 that can be arranged on the output spindle 14 can be mounted/demounted in a user-friendly manner. In the defined mounting position, the output spindle 14 can preferably be stopped and/or held, by means of the positioning unit 16, in a preset, fixed position relative to the housing unit 44. For example, it is conceivable that an alignment of the insert tool 18 and/or of the output spindle 14 can be sensed by means of the positioning unit 16, and that the drive unit 26, in particular an electric-motor unit, can be controlled in such a manner that the insert tool 18 and/or the output spindle 14 can be stopped and/or held in the defined position. It can advantageously be made possible, for example, for information provided on the insert tool 18 (advertising, indication of direction of rotation, characteristic values or the like) always to be aligned at the same position relative to the housing unit 44 as a result of the output spindle 14 being stopped and/or held at a defined position, in particular so as to be easily and reliably read by an operator, such that advantageous delivery of information to an operator can be achieved. The positioning unit 16 may be realized as a magnetic, electronic and/or mechanical positioning unit 16.

The positioning unit 16 preferably has at least one actuator element 20, 22, 24, which is designed to act mechanically and/or magnetically at least upon the output spindle 14, upon the insert tool 18 arranged on the output spindle 14, or upon a drive unit 26 of the power tool 14 that is able to drive the output spindle 14 (see FIGS. 1 and 2). The actuator element 20, 22, 24 is designed to move a mechanical and/or electromagnetic braking element 28 of the positioning unit 16, or a mechanical engagement element 32 (see FIG. 2) of the positioning unit 16, that is designed to act at least upon the output spindle 14, upon the insert tool 18 arranged on the output spindle 14, or upon the drive unit 26 that is able to drive the output spindle 14.

Preferably, the positioning unit comprises at least one actuator element 20, which is designed to act mechanically and/or magnetically at least upon the output spindle 14, upon the insert tool 18 arranged on the output spindle 14, or upon a drive unit 26 of the power tool 14 that is able to drive the output spindle 14. Preferably, the positioning unit 16 comprises at least one further actuator element 22, which is designed to move the mechanical engagement element 32. Preferably, the positioning unit 16 comprises at least one additional actuator element 24, which is designed to move the mechanical and/or electromagnetic braking element 28.

The positioning unit 16 has at least one damping element 34, which is designed to damp a mechanical engagement of an engagement element 32 of the positioning unit 16, in particular in the output spindle 14 or in the insert tool 18 arranged on the output spindle 14 (see FIG. 2). The damping element 34 may be arranged on the engagement element 32, or on a recess (not represented here) in which the engagement element 32 engages.

The positioning device 10 comprises at least one open-loop or closed-loop control unit 36, and at least one sensor unit 38, which has at least one sensor element 40 for sensing a position of the output spindle 14 and/or of the insert tool 18 arranged on the output spindle 14, wherein a signal of the sensor element 40 can be processed by the open-loop or closed-loop control unit 36 for the purpose of controlling an actuator 20, 22, 24 of the positioning unit 16 by open-loop and/or closed-loop control. The sensor element 40 is realized as a rotational-speed sensor, which is designed to sense at least one rotational speed of the output spindle 14 and/or of the insert tool 18 arranged on the output spindle 14, wherein the open-loop or closed-loop control unit 36 determines a tripping instant of at least one actuator element 20, 22, 24 of the positioning unit 16, in particular at least one of the actuator elements 20, 22, 24, in dependence on the sensed rotational speed. The sensor unit 38 comprises at least one, in particular further, sensor element 42 (see FIG. 2) for sensing at least one characteristic and/or item of information of an insert tool 18 arranged on the output spindle 14, wherein a defined position, in which the output spindle 14, and/or the insert tool 18 arranged on the output spindle 14, can be stopped and/or held automatically, can be selected automatically, by means of the open-loop or closed-loop control unit 36, in dependence on the sensed characteristic and/or information of the insert tool 18 arranged on the output spindle 14.

FIG. 2 shows a sectional view of the quick-change clamping device 50 arranged on the output spindle 14. The quick-change clamping device 50 comprises at least one driver means 52, and a clamping means that can be moved relative to the driver means 52. The clamping means 54 preferably has at least two hook means 56, 58, realized as hook jaws, that are mounted so as to be pivotable and/or rotatable relative to each other about a clamping-means rotational axis 60 of the clamping means 54. In FIG. 2 the hook means 56, 58 are represented in a release state of the clamping means 54. Preferably, the two hook means 56, 58 can be moved synchronously. It is also conceivable, however, that the hook means 56, 58, in an alternative design of the clamping means 54, can be moved independently of each other. The clamping means 54 has at least one guide element 62, realized as a guide pin, on or about which the hook means 56, 58 are guided, and at least one bearing element 64, realized as a bearing pin, that is designed to carry the hook means 56, so as to be pivotable and/or rotatable about the clamping-means rotational axis 60 of the bearing element 64. The clamping means 54 has at least two guide recesses 66, 68, realized as guide grooves, that each form a guide path for guiding the hook means 56, 58. One of the guide recesses 66, 68 in each case is arranged on one of the hook means 56, 58. The guide element 62 engages in both guide recesses 66, 68, and is designed to move the hook means 56, 58. The two hook means 56, 58 are preferably symmetrical in relation to each other. The guide recesses 66, 68 are preferably symmetrical in relation to each other. Preferably, the movement of the two hook means 56, 58 is substantially synchronous, such that both hook means 56, 58 can be moved jointly either into a fastening position or in a release position.

The output spindle 14 can be driven, in particular in rotation, about an output axis 70 of the power tool 12. Insert tools 18 of differing dimensions, in particular of differing material thicknesses, can be fixed by the hook means 56, 58, by means of the clamping means 54, in dependence on a pivot angle of a clamping face 72, 74 of the clamping means 54 angled relative to the output axis 70. The hook means 56, 58 each have at least one radial clamping recess 76, 78 that is designed to clamp the insert tool 18 in a fastening state, at least in the axial direction of the output spindle 14, and to release it in a release state. The clamping recesses 76, 78 each have at least one of the clamping faces 72, 74 for transmitting an at least axially acting force to the insert tool 18. In the fastening state the clamping faces 72, 74 each extend transversely, in particular at least substantially perpendicularly, in relation to the output axis 70.

FIG. 3 shows a detail view of the driver means 52 and of the clamping means 54. The driver means 52 comprises at least one torque transmission region 80 for transmitting a driving force to the insert tool 18. The torque transmission region 80 comprises at least two torque transmission extensions 82, 84. Each of the torque transmission extensions 82, 84 has at least one straight output edge and/or a flat output face. The output edge and/or the output face extend(s) at least substantially parallel to a radial direction with respect to the output axis 70. The output edge and/or the output face are/is angled contrary to a direction of rotation of the output spindle 14. The torque transmission extensions 82, 84 are arranged evenly, according to an n-fold symmetry, on the driver means 52.

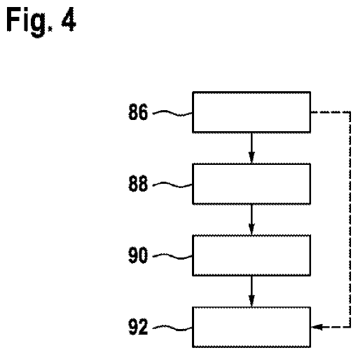

FIG. 4 shows a method sequence of a method for positioning the output spindle 14 of the power tool 12, and/or the insert tool 18 arranged on the output spindle 14 of the power tool 12, by means of the positioning device 10. In at least one method step 92, the output spindle 14, and/or the insert tool 18 arranged on the output spindle 14, are/is stopped and/or held automatically, in particular without a user intervention, in at least one defined position by means of the positioning unit 16 of the positioning device 10, in particular starting from a working motion of the output spindle 14 and/or of the insert tool 18 arranged on the output spindle. In at least one method step 86, at least one position of the output spindle 14 and/or of the insert tool 18 arranged on the output spindle 14 is sensed by means of the sensor unit 38 of the positioning device 10, and the sensed position is processed by the open-loop or closed-loop control unit 36 of the positioning device 10 for the purpose of open-loop and/or closed-loop control of an actuator element 20, 22, 24 of the positioning unit 16 by the open-loop or closed-loop control unit 36. It is conceivable, in at least one method step 88, for a position of the output spindle 14 and/or of the insert tool 18 arranged on the output spindle 14 to be calculated in dependence on a signal determined by means of a drive-unit sensor, and for the calculated position to be processed by the open-loop or closed-loop control unit 36 of the positioning device 10 for the purpose of open-loop and/or closed-loop control of an actuator element 20, 22, 24 of the positioning unit by the open-loop or closed-loop control unit 36, and/or taken into account in an evaluation of a signal of the sensor unit 38. It is conceivable, in at least one method step 90, for a defined position of the output spindle 14 and/or of the insert tool 18 arranged on the output spindle 14 that is selected by an operator, by means of an input unit, to be taken into account by the open-loop or closed-loop control unit 36 for the purpose of stopping and/or holding the output spindle 14 and/or the insert tool 18. Further method steps, considered appropriate by persons skilled in the art, may also be provided.

1. A positioning device for a power tool having an output spindle configured to be driven in rotation, comprising:
at least one positioning unit, which is designed to automatically stop and/or hold at least one of the output spindle and an insert tool arranged on the output spindle in at least one defined position.

2. The positioning device as claimed in claim 1, wherein the positioning unit has at least one actuator element, which is designed to act at least one of mechanically and magnetically at least upon the output spindle, upon the insert tool arranged on the output spindle, or upon a drive unit of the power tool that is configured to drive the output spindle.

3. The positioning device as claimed in claim 2, wherein the actuator element is designed to move a mechanical and/or electromagnetic braking element of the positioning unit or a mechanical engagement element of the positioning unit, which is designed to act at least upon the output spindle, the insert tool, or the drive unit.

4. The positioning device as claimed in claim 1, wherein the positioning unit comprises an engagement element and at least one damping element, which is designed to damp a mechanical engagement of the engagement element.

5. The positioning device as claimed in claim 1, further comprising:
at least one open-loop or closed-loop control unit; and
at least one sensor unit comprising at least one sensor element configured to sense a position of the output spindle and/or of the insert tool arranged on the output spindle,
wherein the at least one open-loop or closed-loop control unit is configured to process a signal of the sensor element so as to control an actuator element of the positioning unit by open-loop and/or closed-loop control.

6. The positioning device as claimed in claim 5, wherein:
the sensor element is configured as a rotational-speed sensor designed to sense at least one rotational speed of the output spindle or of the insert tool arranged on the output spindle, and
the open-loop or closed-loop control unit determines a tripping instant of the actuator element of the positioning unit based on the sensed rotational speed.

7. The positioning device as claimed in claim 1, further comprising:
at least one open-loop or closed-loop control unit; and
at least one sensor unit comprising at least one sensor element configured to sense at least one characteristic and/or item of information about the insert tool arranged on the output spindle,
wherein the at least one open-loop or closed-loop control unit is configured to automatically select the defined position at which the at least one of the output spindle and the insert tool is stopped and/or held automatically based on the sensed characteristic and/or item of information about the insert tool.

8. A power tool, comprising:
at least one housing unit;
at least one output spindle configured to be driven in rotation relative to the housing unit; and
at least one positioning device comprising at least one positioning unit, which is designed to automatically stop and/or hold at least one of the output spindle and an insert tool arranged on the output spindle in at least one defined position.

9. A method for positioning at least one of an output spindle of a power tool, and an insert tool arranged on the output spindle of the power tool, with a positioning device, comprising:
automatically stopping and/or holding the at least one of the output spindle and the insert tool in at least one defined position with a positioning unit of the positioning device.

10. The method as claimed in claim 9, further comprising:
sensing, with a sensor unit or the positioning device, at least one position of the output spindle and/or of the insert tool; and
processing the sensed position with an open-loop or closed-loop control unit of the positioning device so as to control an actuator element of the positioning unit with open-loop and/or closed-loop control via the open-loop or closed-loop control unit.

11. The positioning device as claimed in claim 1, wherein the positioning device is arranged on a hand-held power tool.

12. The positioning device as claimed in claim 1, wherein:
the positioning unit is designed to stop and/or hold the at least one of the output spindle and the insert tool automatically without a user intervention, in the at least one defined position, and
the at least one defined position is a defined rotational position relative to a housing unit of the power tool starting from a working motion of the output spindle and/or of the insert tool.

13. The positioning device as claimed in claim 4, wherein the at least one damping element is designed to damp the mechanical engagement of the engagement element in the output spindle or in the insert tool.

14. The power tool as claimed in claim 8, wherein the power tool is a hand-held power tool.

15. The method as claimed in claim 9, wherein the automatically stopping and/or holding of the at least one of the output spindle and the insert tool includes automatically stopping and/or holding the at least one of the output spindle and the insert tool in the at least one defined position without a user intervention, starting from a working motion of the output spindle and/or of the insert tool.
